(19) United States
(12) Patent Application Publication
(10) Pub. No.: US 2014/0368767 A1
(43) Pub. Date: Dec. 18, 2014

(54) SURFACE LIGHT EMITTING DEVICE AND LIQUID CRYSTAL DISPLAY APPARATUS

(71) Applicant: NLT TECHNOLOGIES, LTD., Kawasaki (JP)

(72) Inventors: Hideaki SUGAWARA, Kawasaki (JP); Masato MAKI, Kawasaki (JP)

(73) Assignee: NLT TECHNOLOGIES, LTD., Kawasaki (JP)

(21) Appl. No.: 14/293,633

(22) Filed: Jun. 2, 2014

(30) Foreign Application Priority Data
Jun. 17, 2013 (JP) 2013-126246

(51) Int. Cl. F21V 8/00; G02F 1/1335

(52) U.S. Cl. CPC G02B 6/0031; G02F 1/133603; G02F 1/133605
USPC 349/62; 362/609

(57) ABSTRACT

Provided are a surface light emitting device and a liquid crystal display apparatus equipped with the surface light emitting device. The surface light emitting device includes: a light guide plate including a side surface where light enters, a principal surface where the light goes out and a rear surface opposite to the principal surface; and a reflection sheet arranged on the rear surface of the light guide plate; a substrate arranged with facing the side surface of the light guide plate. The surface light emitting device further includes: plural light emitting bodies arranged along a longitudinal direction of the substrate and mounted on a surface of the substrate; a frame and a rear frame holding the substrate, the light guide plate and the reflection sheet; and one or more reflecting bodies arranged around a part of the light emitting bodies and extending along a longitudinal side of the substrate.

### TECHNICAL FIELD

The present invention relates to a surface light emitting device and a liquid crystal display apparatus. In particular, the present invention relates to a surface light emitting device which can conduct surface light emission by converting light from a light source in which plural light emitting bodies are arrayed, and relates to a liquid crystal display apparatus equipped with the surface light emitting device.

### BACKGROUND

In recent years, LCDs (Liquid Crystal Displays) have been used in various fields. Especially, LCDs for industrial or medical use are desired to have high luminance, excellent luminance evenness and a long life. LCDs employ backlights. As backlights, there are known surface light emitting devices which can convert light emitted from a light source such as LEDs (Light Emitting Diodes) into surface light through a light guide plate and optical sheets.

As a way to achieve high luminance of an LCD, Japanese Unexamined Patent Application Publication (JP-A) No. 2007-041471 discloses the following technology. In the technology, as shown in FIG. 20, there is provided a light source section in which a light-emitting-element array module is mounted on a circuit board. The light-emitting-element array module includes a light outputting section formed by arranging plural light emitting elements on an elongated substrate (the module substrate in FIG. 20) along the longitudinal direction of the substrate and by embedding the plural light emitting elements within a transparent material. In the light source section, two deformable reflecting members are arranged so as to surround a space between the light outputting section of the light-emitting-element array module and the light incident surface of the light guide plate. The light source section is directly fixed onto an outer case which has excellent heat conduction and is different from a frame supporting the light guide plate. A scattering sheet, a prism sheet and a reflecting sheet are further provided on the principal surface and the rear surface of the light guide plate.

As another way, JP-A No. 2009-158315 discloses the following light source module. As shown in FIG. 21, the light source module includes plural light emitting elements arranged in a line. The light source module further includes first reflectors put on both sides of the line of the light emitting elements, second reflectors each put between the neighboring light emitting elements, a resin section put between the first reflectors and covering the light emitting elements and the second reflectors, and a light scattering sheet arranged above the light emitting elements. The second reflectors are lower than the first reflectors, and higher than the light emitting elements. The light scattering sheet has plural pits and plural depressed parts which are deeper than the pits, and the pits and the depressed parts are formed on the opposite surface of the light scattering sheet from the surface facing the resin section.

As a way to enhance the luminance evenness of an LCD, JP-A No. 2009-245664 discloses the following light emitting device. As shown in FIG. 22, the light emitting device includes light emitting elements, a transparent member and a sealing resin layer, where the transparent member is arranged on the optical paths (Rc, Rd, Re and Rf in FIG. 22) of the light emitting elements and has a refractive index being different from that of the sealing resin layer. The light emitting device further includes bottom reflecting members arranged on a substrate where the light emitting elements are installed. Each bottom reflecting member has slopes (the first and second slopes in FIG. 22) inclining from the installation surface of the substrate. The light emitting device further includes side reflecting members arranged on the both sides of the light emitting elements and extending along the direction of the array of the light emitting elements. Each of the side reflecting members has a side-wall surface which faces the light emitting elements and inclines so as to go toward the light emitting elements as a position on the side-wall surface goes from the installation surface to the surface of the sealing resin layer.

FIG. 20 is a cross-sectional view illustrating a structure of the backlight disclosed in JP-A No. 2007-041471. In this structure, there are arranged reflecting members between the light source section and the light guide plate so that light of LEDs can be utilized effectively. However, the reflecting members are so thin that the reflecting members may shrink or expand because of heat coming from the LEDs and may be curved or deformed. It changes the efficiency of the reflecting members to guide light of the LEDs to the light guide plate, which changes the luminance distribution of the backlight and decreases the luminance evenness of the backlight. Further, this technology hardly increases the luminance of a certain area in the light emitting surface of the backlight selectably and does not contribute to an enhancement of the luminance evenness. Further, the reflecting members are fixed to the light guide plate and the light-emitting-element array module so as to surround the light incident section of the light guide plate, and it requires positioning and fixing work of the reflecting members at the both sides of the light guide plate and light-emitting-element array module, which makes assembly workability of the backlight worse.

FIG. 21 is a cross-sectional view illustrating a structure of a backlight module disclosed in JP-A No. 2009-158315, which shows a technology to scatter light of LEDs to make the light enter a light guide plate effectively in order to convert point light sources as the LEDs into a surface light source. This technology does not contribute to an increase of luminance of the backlight module and to an enhancement of luminance evenness of the backlight module.

FIG. 22 is a cross-sectional view illustrating a structure of the light emitting device disclosed in JP-A No. 2009-245664, which shows a technology about a LED packaging structure. This technology needs a development of dedicated LEDs, is less-versatile, and is hardly employed for backlights and liquid crystal display apparatuses using LEDs which have already been put into the market. Further, the disclosed technology is a technology that transparent members are added onto the optical paths of light going out from the light emitting elements so as to scatter the outgoing light and obtain a flat light emission. However, this technology uses a scattering effect of the whole incident light which enters the light guide plate. The technology does not increase the luminance of a certain part in the light emitting surface of the backlight selectably and does not contribute to an enhancement of luminance evenness of the backlight. Further, adding the transparent members onto the optical paths of the light from the light emitting elements decreases the light-outgoing efficiency by the quantity of light corresponding to the transmittance of the transparent members, which decreases the luminance of the light emitting device.

As described above, the conventional technologies aim at an enhancement of light utilization efficiency about light coming from a light source and entering a light guide plate, and still have matters to be solved, such as an aging degradation about the reflectance of a reflecting structure put around a light source and a deterioration of the assembly workability of each device. Further, those technologies also aim at an increase of luminance of each device and do not realize a sufficient enhancement of luminance evenness of a surface light emitting device.

### SUMMARY

In view of the above problems, there are provided illustrative surface light emitting devices which can solve an aging degradation of reflectance of a reflecting structure put around a light source and a deterioration of the assembly workability and further can achieve an enhancement of the luminance evenness, and are provided illustrative liquid crystal display apparatuses each equipped with such the surface light emitting device, as embodiments of the present invention.

A surface light emitting device illustrating one aspect of the present invention is a surface light emitting device comprising: a light guide plate in a flat plate shape, including a side surface through which light enters, a principal surface through which the light goes out and a rear surface opposite to the principal surface. The surface light emitting device further comprises a reflection sheet arranged on the rear surface of the light guide plate; a substrate arranged with facing the side surface of the light guide plate; and a plurality of light emitting bodies arranged along a longitudinal direction of the substrate and mounted on a surface of the substrate, the surface facing the light guide plate. The surface light emitting device further comprises a frame and a rear frame holding at least the substrate, the light guide plate and the reflection sheet by being arranged at a side of the principal surface and a side of the rear surface of the light guide plate, respectively; and one or more reflecting bodies arranged around a part of the light emitting bodies and extending along a longitudinal side of the surface of the substrate. Other features of illustrative embodiments will be described below.

### BRIEF DESCRIPTION OF THE DRAWINGS

Embodiments will now be described, by way of example only, with reference to the accompanying drawings which are meant to be exemplary, not limiting, and wherein like elements numbered alike in several figures, in which:

FIG. 1 is a partial cross-sectional view illustrating an example of the structure of a surface light emitting device relating to Example 1;

FIGS. 2A, 2B and 2C are a front view and a side view illustrating an example of the arrangement of reflecting bodies (which are arranged at the both sides of light emitting bodies) in the surface light emitting device relating to Example 1, and a top view illustrating a positional relationship of a light guide plate and a substrate in the surface light emitting device relating to Example 1;

FIG. 3 is a partial cross-sectional view illustrating another example of the structure (reflecting bodies are fixed onto a rear frame) of the surface light emitting device relating to Example 1;

Each of FIGS. 4A to 4F is a cross-sectional view illustrating an example of the shape of reflecting bodies relating to Example 1;

FIGS. 5A and 5B are a front view and a side view illustrating an example of the arrangement of reflecting bodies put at the center of the substrate;

FIG. 6 is a diagram illustrating a relationship of the length of reflecting bodies and the length of the light emitting surface of the structure shown in FIGS. 5A and 5B;

FIG. 7 is a diagram illustrating a relationship of the size ratio of the reflecting bodies (“length of the reflecting bodies”/“length of the light emitting surface”) and central luminance of the light emitting surface of the structure shown in FIGS. 5A and 5B;

Each of FIGS. 8A and 8B is a diagram illustrating an enhancement of luminance evenness of the surface light emitting device relating to Example 1;

FIG. 9 is a diagram illustrating the relationship of the length of the reflecting bodies and the length of the light emitting surface of the structure shown in FIGS. 2A to 2C;

FIG. 10 is a diagram illustrating the relationship of the size ratio of the reflecting bodies (“length of reflecting bodies”/“length of the light emitting surface”), the maximum luminance and the minimum luminance of the structure shown in FIG. 9;

FIG. 11 is a diagram illustrating the relationship of the size ratio of the reflecting bodies (“length of reflecting bodies”/“length of the light emitting surface”) and the luminance evenness of the structures shown in FIG. 9;

FIG. 12 is a partial cross-sectional view illustrating another example of the structure (in the case that the reflecting body or bodies are arranged at one side of the light emitting bodies) of the surface light emitting device relating to Example 1;

FIGS. 13A and 13B are a front view and a side view illustrating another example of the structure (the reflecting bodies arranged at one side of the light emitting bodies) of the surface light emitting device relating to Example 1;

FIGS. 14A and 14B are a front view and a side view illustrating another example of the structure (the reflecting bodies in an asymmetric arrangement) of the surface light emitting device relating to Example 1;

FIGS. 15A and 15B are a front view and a side view illustrating another example of the structure (the reflecting bodies in an asymmetric arrangement) of the surface light emitting device relating to Example 1;

FIG. 16 is a partial cross-sectional view illustrating an example of the structure of a surface light emitting device relating to Example 2;

FIG. 17 is a partial cross-sectional view illustrating another example of the structure of the surface light emitting device relating to Example 2;

FIGS. 18A and 18B are a front view and a side view illustrating an example of the arrangement of reflecting bodies of a surface light emitting device relating to Example 3;

FIG. 19 is a perspective view illustrating a liquid crystal display apparatus relating to the present examples;

FIG. 20 is a cross-sectional view illustrating the structure of a backlight disclosed in a conventional art;

FIG. 21 is a cross-sectional view illustrating the structure of a backlight module disclosed in another conventional art; and

FIG. 22 is a cross-sectional view illustrating the structure of a light emitting device disclosed in another conventional art.

### DETAILED DESCRIPTION

Illustrative embodiments of surface light emitting devices and a liquid crystal display apparatus will be described below with reference to the drawings. It will be appreciated by those of ordinary skill in the art that the description given herein with respect to those figures is for exemplary purposes only and is not intended in any way to limit the scope of potential embodiments may be resolved by referring to the appended claims.

According to illustrative surface light emitting devices as embodiments of the present invention, an aging degradation of the reflectance of reflecting structures around a light source and a deterioration of the assembly workability can be solved and an enhancement of the luminance evenness can be realized because of the following reasons.

That is, there is provided the following surface light emitting device so as to increase the luminance of a low-luminance area of the light emitting surface of the surface light emitting device and decrease the difference between the maximum luminance and the minimum luminance. The surface light emitting device includes at least a light guide plate in a flat plate shape, a reflection sheet arranged on the rear surface of the light guide plate; a substrate arranged with facing one side surface of the light guide plate; a plurality of light emitting bodies arrayed along the longitudinal direction of the substrate and mounted on the surface, which faces the light guide plate, of the substrate; and a frame and a rear frame holding the above members by being arranged at a side of the principal surface and a side of the rear surface of the light guide plate, respectively. The surface light emitting device further includes one or more reflecting bodies arranged in an area where one or more of the light emitting bodies corresponding to a low luminance area, such as light emitting bodies at the both ends of the substrate, are mounted. The reflecting bodies extend along a longitudinal side of the surface of the substrate and are mounted at at least one of the upper side (the side closer to the primary surface of the light guide plate) and the lower side (the side closer to the rear surface of the light guide plate) of the light emitting bodies.

As illustrated in the descriptions about the background, high luminance, luminance evenness and a longer life are desired for surface light emitting devices which can convert light from a light source such as LEDs into surface light through a light guide plate, a reflection sheet and optical sheets. However, the above-described conventional technologies aim at an enhancement of a light utilization efficiency of light coming from a light source and entering a light guide plate, and still have matters to be solved, such as an aging degradation about the reflectance of a reflecting structure put around a light source and a deterioration of the assembly workability of each device. Further, the above-described conventional technologies also aim at an increase of luminance of each device and do not realize a sufficient enhancement of luminance evenness of a surface light emitting device.

In view of the matters, an illustrative surface light emitting device as one embodiment of the present invention employing a light source including plural light emitting bodies arrayed in a line, includes one or more reflecting bodies arranged around a light emitting body or bodies having relatively low luminance (that is, having lower luminance than other light emitting bodies) so as to enhance the luminance of the area where the one or more reflecting bodies are arranged, which enhances the luminance evenness of the whole of the surface light emitting device.

Concretely, the surface light emitting device includes a light guide plate in a flat plate shape, including a side surface through which light enters and a principal surface through which the light goes out. The surface light emitting device further includes a reflection sheet arranged on a rear surface of the light guide plate; a substrate arranged with facing the side surface of the light guide plate; a plurality of light emitting bodies arranged along a longitudinal direction of the substrate and mounted on a surface of the substrate, facing the light guide plate. The surface light emitting device further includes a frame and a rear frame holding the above members by being arranged at the principal-surface side and the rear-surface side of the light guide plate, respectively. In the surface light emitting device, one or more reflecting bodies are arranged around a part of the light emitting bodies corresponding to an area having a relatively low luminance, such as light emitting bodies on the both side of the substrate, and are mounted with an adhesive at at least one of the upper side (the side closer to the principal surface of the light guide plate) of the light emitting bodies and the lower side (the side closer to the rear surface of the light guide plate) of the light emitting bodies with extending along a longitudinal side of the surface of the substrate. Further, the one or more reflecting bodies may be arranged so that a ratio of the length of the one or more reflecting bodies to the length of the plural light emitting bodies in the direction of the array of the light emitting bodies (or a width of the principal surface of the light guide plate) is 10% or more, and is 70% or less, where being measured in the longitudinal direction of the substrate. Further, the one or more reflecting bodies may be arranged such that at least one of the one or more reflecting bodies has a top located between light emitting surfaces of the light emitting bodies and the side surface of the light guide plate, when being viewed along a normal direction of the substrate.

Such the embodiment can enhance the luminance of an area around a light emitting body or bodies having relatively low luminance, can reduce the difference between the maximum luminance and the minimum luminance, and can enhance the luminance evenness of the surface light emitting device. Further, the one or more reflecting bodies are fixed with an adhesive on a member such as the substrate, which restricts an aging degradation of the reflectivity of the one or more reflecting bodies and enhances the assembly workability of the surface light emitting device.

### EXAMPLE 1

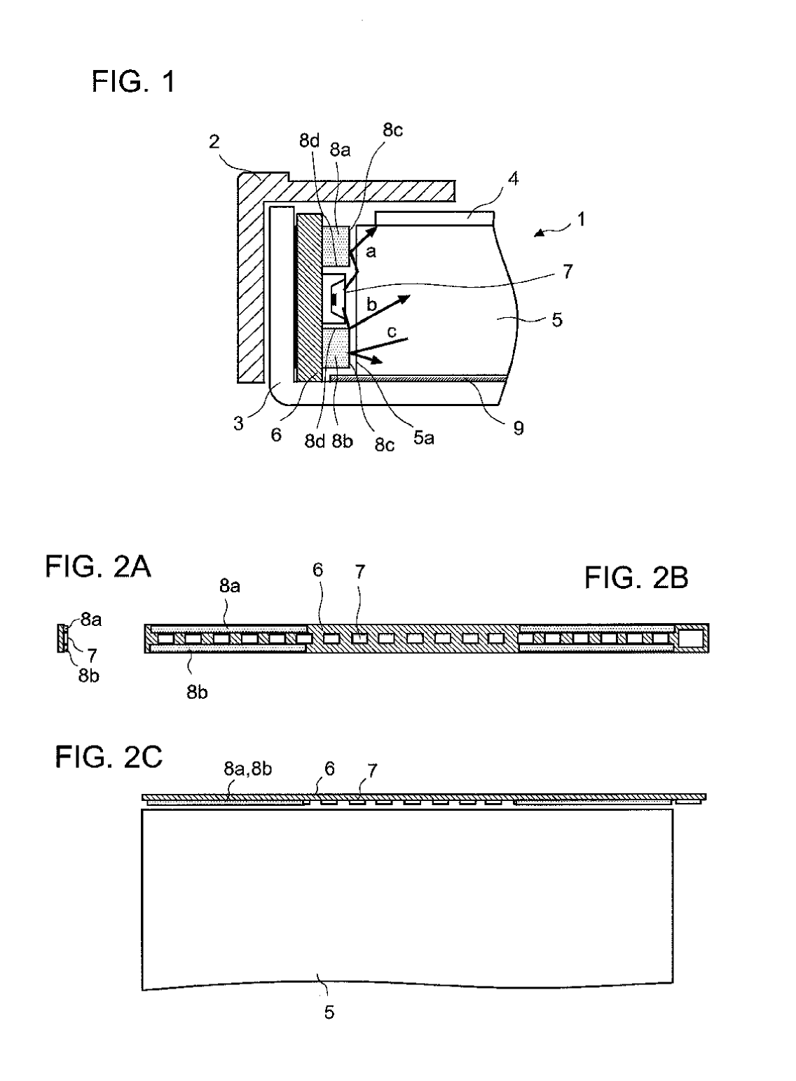

In order to describe the above embodiments of the present invention in more detail, descriptions will be given to a surface light emitting device of Example 1 with reference to FIG. 1 to FIG. 15B.

A surface light emitting device of the present example can be used for a backlight of a liquid crystal display apparatus, and can change light emitted from light emitting bodies such as LEDs into surface light so as to be used for lighting apparatuses, signboards, light boxes and like.

FIG. 1 is a cross-sectional view illustrating the structure of a surface light emitting device of the present example. There are provided rear frame 3 whose cross section is bent into an L shape, reflection sheet 9, light guide plate 5 in a flat plate shape and optical sheet 4. Light guide plate 5 is fixed through reflection sheet 9 to the bottom surface of rear frame 3. Light guide plate 5 has a rear surface fixed to rear frame 3, and a light emitting surface which is the principal surface opposite to the rear surface. On the light emitting surface, optical sheet 4 such as a light scattering sheet and a prism sheet are arranged.

Plural light emitting bodies 7 such as LEDs are arranged to face a side surface (light incident surface 5a) of light guide plate 5, and light which has entered light guide plate 5 through the side surface (light incident surface 5a) goes out through the principal surface of light guide plate 5. The light emitting bodies 7 are arrayed along the longitudinal direction of the substrate and are fixed with an adhesive to substrate 6 on the surface facing the light guide plate 5. Substrate 6 is fixed to a side surface of the rear frame 3 with a screw or an adhesive so as to face the side surface (light incident surface 5a) of light guide plate 5. Around a part of light emitting bodies 7, reflecting bodies 8 (upper reflecting body 8a and lower reflecting body 8b) are arranged and are fixed to substrate 6 with an adhesive. Then, frame 2 covers the above members (in other words, frame 2 and rear frame 3 hold the above members by being arranged at the principal-surface side and the rear-surface side of light guide plate 5) to form the surface light emitting device 1.

FIGS. 2A, 2B and 2C are a front view and a side view illustrating light emitting bodies 7 viewed from light incident surface 5a of light guide plate 5, and a top view illustrating a positional relationship of light guide plate 5 and substrate 6. Substrate 6 has a shape being a little larger than a side surface of light guide plate 5 in a flat plate shape. On substrate 6, plural light emitting bodies 7 are arranged in one or more lines (single line in FIGS. 2A to 2C) along light incident surface 5a of light guide plate 5, to form a linear light source. Around a part of light emitting bodies 7 (on the upper and lower sides of a part of light emitting bodies 7 at the both ends of the substrate 6 or the line of light emitting bodies 7 in FIG. 2B), upper reflecting body 8a and lower reflecting body 8b are arranged with extending in the longitudinal direction of substrate 6 (the direction of the array of light emitting bodies 7). In FIG. 2B, the white square at the right-side end of substrate 6 is a chip for controlling light emitting bodies 7.

Reflecting bodies 8 are formed of a polymer material represented by PET (polyethylene terephthalate), which is preferable to be a foamed PET material (where “foamed” means that a material includes air bubbles) in white color. When employing a material including air bubbles, reflecting bodies 8 can scatter light inside their bodies. As an example of a preferable material of reflecting bodies 8, there is cited “MCPET” manufactured by Furukawa Electric Co., Ltd., which is excellent in weather resistance and heat resistance and can maintain the reflectance of reflecting bodies 8 for a long period of time. Each of reflecting bodies 8 can include an ultraviolet absorbing agent or can be equipped with an ultraviolet absorbing film on the surface. Adding those materials to reflecting bodies 8, can inhibit reflecting bodies 8 from yellowing, make the reflectance of reflecting bodies 8 stable for a long period of time and elongate the luminance life time of surface light emitting device 1.

The above-described high polymer material is not limited to PET, and the following materials can be used alternatively: polyethylene, polypropylene, polystyrene, ABS resin, polyvinyl chloride, polycarbonate, polyamide, polybutylene terephthalate, poly oxymethylene, polyacetal, modified polyphenylene ether. For an ultraviolet absorbing agent and an ultraviolet absorbing film, the following materials can be used: octyl methoxycinnamate, oxybenzone, and t-butylmethoxydibenzoylmethane.

The reflecting bodies 8 can be produced in the following manner. There is prepared a material in a flat plate shape, formed of a foamed raw material and having a predetermined thickness. The material may be cut into strips by press working with a die on which depressions and protrusions are put to form reflecting bodies 8 into an arbitrary shape. Reflecting bodies 8 which have been cut into strips preferably have the thickness of 0.25 mm or more, because they become difficult to be handled if they become too thin. Needless to say, reflecting bodies 8 may be formed to have an arbitrary cross section by another type of processing such as injection molding or extrusion molding.

For the adhesive agent to be used for fixing reflecting bodies 8 or light emitting bodies 7 onto substrate 6, a material in a silicon group or a group of acrylic resins is preferably used. The total thickness of the adhesive agent is preferably 250 gm or less. As the adhesive agent, a material having high heat conductivity being 0.2 W/m·K or greater is preferably used in order to effectively propagate heat generated by light emitting bodies 7.

FIGS. 1 and 2A to 2C illustrate just an example of surface light emitting device 1 of the present example, and the shape and arrangement of each of the structural components and their formation can be changed arbitrarily without departing from the sprit and scope of the present invention. For example, those may be arbitral as far as reflecting bodies 8 are arranged in a space surrounded by light guide plate 5, rear frame 3, substrate 6 and frame 2 and are fixed with the above-described adhesive agent.

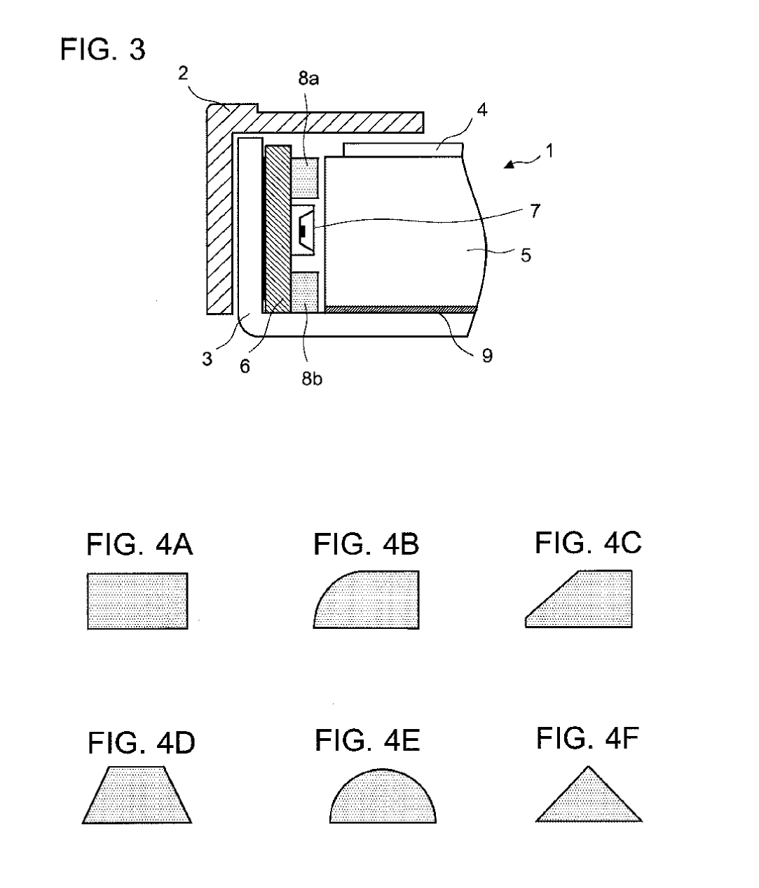

Concretely, as shown in FIG. 3, reflecting bodies 8 may be fixed onto another place than substrate 6. For example, lower reflecting body 8b may be fixed onto rear frame 3 with the above-described adhesive agent. As another example, which is not illustrated, lower reflecting body 8b may be fixed onto reflection sheet 9 held between light guide plate 5 and rear frame 3. As far as reflecting bodies 8 are fixed with a thin adhesive agent, surface light emitting device 1 which is excellent in assembly workability can be realized in low cost even when the reflecting bodies 8 are fixed anywhere.

Reflecting bodies 8 can also have an arbitrary shape. The vertical cross sectional shape of each of reflecting bodies 8 shown in FIG. 1 or FIG. 3 may have a rectangular shape as shown in FIG. 4A, or may have a non-rectangular shape such as a shape including a curve as shown in FIG. 4B, a shape such that a corner is trimmed away as shown in FIG. 4C, a trapezoid as shown in FIG. 4D, a half circle as shown in FIG. 4E and a triangle as shown in FIG. 4F.

Upper reflecting body 8a and lower reflecting body 8b may have the same shape or may have different shapes (upper reflecting body 8a has a rectangular shape and lower reflecting body 8b has a shape including a curve) according to the light emitting property of light emitting bodies 7 and the positional relationship with other members (for example, reflection sheet 9 and rear frame 3), though it is not illustrated. The vertical cross section of each of reflecting bodies 8 of FIG. 1 or FIG. 3 may be constant in the direction of the depth of FIG. 1 or FIG. 3, or may be changed in the depth direction (for example, gradually changed in length or angle of the trimmed part shown in FIG. 4C), though it is not illustrated.

Next, functions of reflecting bodies 8 as a feature of surface light emitting device 1 of the present example will be described. As shown in FIG. 1, reflecting bodies 8 reflect light which has been emitted from light emitting bodies 7 and has not exited through the principal surface of light guide plate 5. For example, as optical path “a” shown in FIG. 1, reflecting bodies 8 reflect, on surface 8c, the light emitted from light emitting bodies 7 and going back to the light emitting bodies 7 with failing in entering light guide plate 5, where a part of the light is scattered inside reflecting bodies 8 and goes out through the surface 8c. As optical path “b” shown in FIG. 1, reflecting bodies 8 reflect, on surface 8c and side surface 8d, the light which has been emitted from light emitting bodies 7 and is going to reflecting bodies 8, where a part of the light is scattered inside reflecting bodies 8 and goes out through the surface 8c and the side surface 8d. As optical path “c” shown in FIG. 1, reflecting bodies 8 reflect, on surface 8c, the light which has been emitted from light emitting bodies 7, entered light guide plate 5, traveled inside light guide plate 5 to be reflected on the surface opposite to light entering surface 5a, traveled inside light guide plate 5 again and gone back to light emitting bodes 7, where a part of the light is scattered inside reflecting bodies 8 and goes out through the surface 8c. As another example of optical path “c”, in a surface light emitting apparatus employing double light incident surfaces, reflecting bodies 8 reflect, on surface 8c, the light which has been emitted from opposing light emitting bodies. Herein, where a part of the light is scattered inside reflecting bodies 8 and goes out through the surface 8c. In order to bring back light having been reflected on light incident surface 5a of light guide plate 5 efficiently, it is preferable that the top of each reflecting body 8 (the positions of surfaces 8c of reflecting bodies 8 in FIG. 1) is set to a position between the light emitting surfaces of light emitting bodies 7 and light incident surface 5a of light guide plate 5 along the normal direction of substrate 6. Herein, under the situation that plural reflecting bodies 8 are arranged as the present example, it is enough that the top position of at least one of reflecting bodies 8 is set to a position between the light emitting surfaces of light emitting bodies 7 and light incident surface 5a of light guide plate 5 along the normal direction of substrate 6.

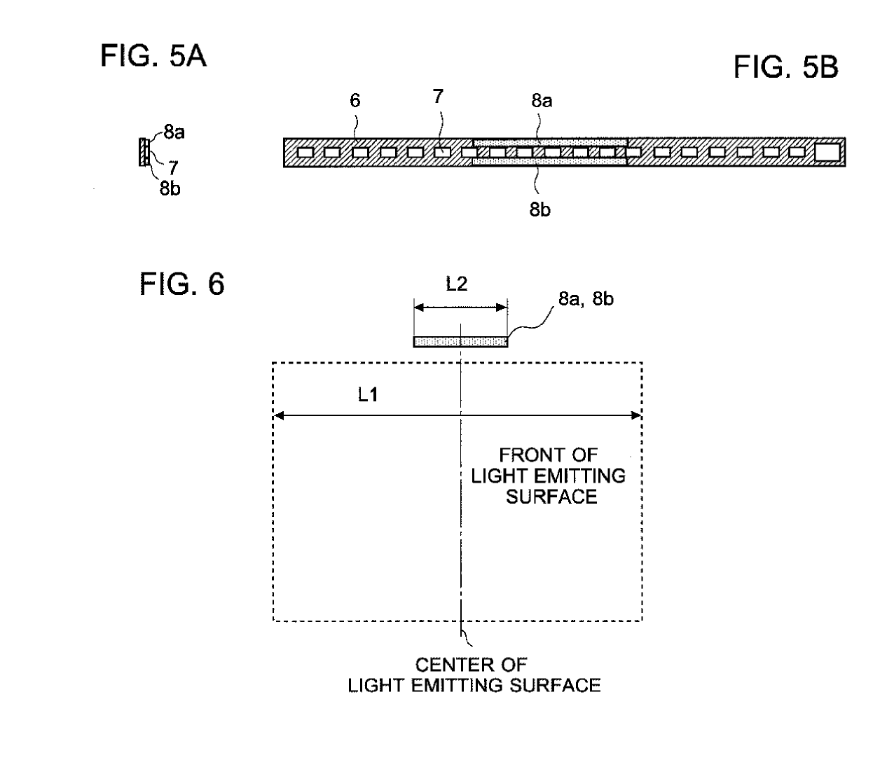

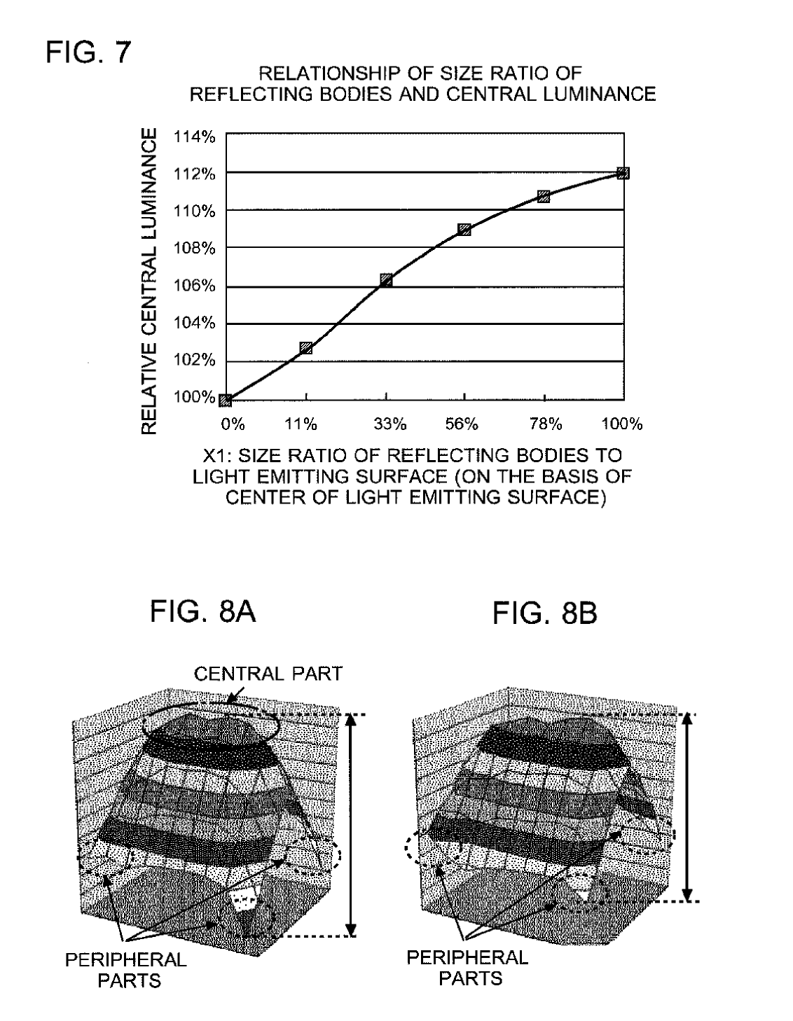

Then, the light reflected by reflecting bodies 8 enters light guide plate 5 again, which enhances the light utilization effect and increases the luminance of surface light emitting device 1. Descriptions of the increase of the luminance will be given with reference to the drawings. FIGS. 5A and 5B illustrate an example that reflecting bodies 8 are arranged at the center of substrate 6. FIG. 6 illustrates the relationship of the length of the front of the light emitting surface in the arrangement shown in FIGS. 5A and 5B (L1: width of light guide plate 5) and the length of reflecting bodies 8 in the longitudinal direction of substrate 6 (L2), where the broken line in FIG. 6 represents the contour of light guide plate 5. FIG. 7 illustrates the ratio of the luminance at the center of the light emitting surface to the reference value (the luminance in the case that no reflecting bodies 8 are arranged) for each of various size ratios of the reflecting bodies 8 to the light emitting surface (X1: L2/L1). As can be seen from FIG. 7, the luminance at the center of the light emitting surface increases as length L2 of reflecting bodies 8 increases.

A general surface light emitting device has a trend that the center of the light emitting surface has high luminance and the luminance decreases as the position approaches a peripheral part. Accordingly, if the luminance of a peripheral part of the light emitting surface which has lower luminance can be increased, the luminance evenness of the whole light emitting surface can be enhanced. In view of that, the present example provides the following arrangement. As shown in FIGS. 2A and 2B, there is provided substrate 6 on which plural light emitting bodies 7 are mounted. Reflecting bodies 8 are arranged on substrate 6, around light emitting bodies 7 at the both ends of substrate 6, to increase the luminance of the areas where reflecting bodies 8 are arranged. This arrangement enhances the luminance evenness. Herein, the luminance evenness can be represented by the value provided by calculating the ratio of the minimum luminance to the maximum luminance of the whole light emitting surface (“minimum luminance”/“maximum luminance”×100). It can be considered that the smaller difference of the maximum luminance and the minimum luminance represents much more excellent luminance evenness.

Each of FIGS. 8A and 8B illustrates the luminance distribution of a general surface light emitting device by using a perspective view. FIG. 8A illustrates an example of the device with no reflecting body and FIG. 8B illustrates an example of the device with reflecting bodies, wherein the Z axis (the axis in the vertical direction) represents the relative value of the luminance and the X and Y axes represent positions. As shown in FIG. 8A, surface light emitting devices have a trend that the light emitting surface has lower luminance as the position gets closer to a peripheral part (the areas enclosed by broken lines in FIG. 8A) and the central part of the light emitting surface (the area enclosed by a one-dot chain line) has high luminance. In contrast, as shown in FIG. 8B, a structure that reflecting bodies 8 are arranged around the end parts of the light emitting surface as shown in FIGS. 2A to 2C increases only the luminance of the peripheral parts without increasing the luminance at the center part of the light emitting surface, which results in the enhancement of the luminance evenness.

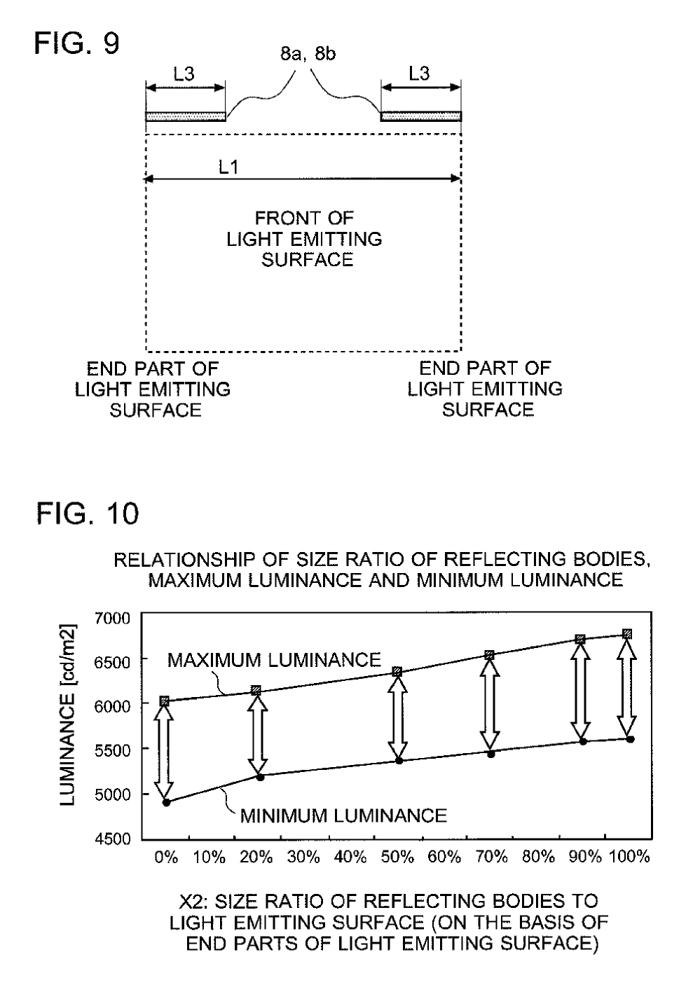

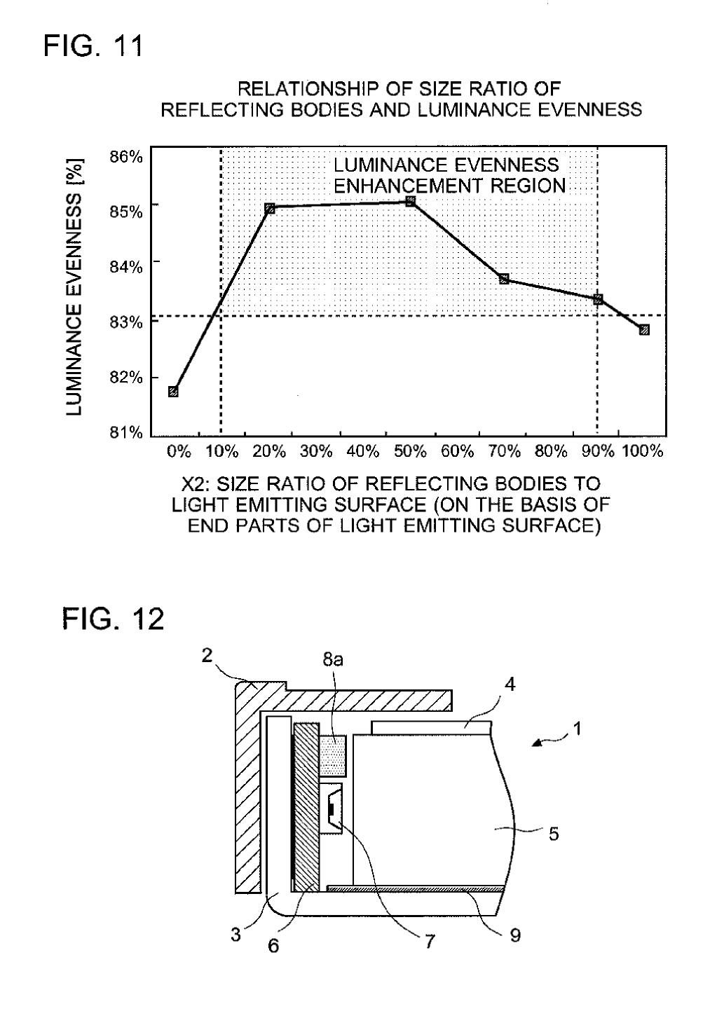

FIG. 9 illustrates the relationship of the length (L1: width of light guide plate 5) of the front of the light emitting surface (the contour of light guide plate 5 is represented by the broken line in FIG. 9) and the length (L3) of each of upper reflecting body 8a and lower reflecting body 8b along the longitudinal direction of substrate 6, under the condition that reflecting bodies 8 having the almost same length to each other are arranged around the end parts at the left and right sides of the light emitting surface. FIG. 10 illustrates the maximum luminance and the minimum luminance of the light emitting surface when the size ratio of reflecting bodies 8 to the light emitting surface (that is, the ratio of the length of reflecting bodies 8 to the width of the principal surface of light guide plate 5 in the longitudinal direction of substrate 6, X2: 2×L3/L1) is changed into various values. FIG. 11 illustrates the luminance evenness obtained by calculating the ratio of the minimum luminance to the maximum luminance (“minimum luminance”/“maximum luminance”×100) when the size ratio (X2) of reflecting bodies 8 to the light emitting surface is changed into various values.

As can be seen from FIG. 10, both of the maximum luminance and the minimum luminance gradually increase as the lengths of upper light reflecting body 8a and lower light reflecting body 8b increase, because the light is utilized more effectively. However, the degree of the increase of the maximum luminance is not the same as that of the minimum luminance. Therefore, as can be seen from FIG. 11, the difference of the maximum luminance and the minimum luminance becomes small in the range that the size ratio (X2) of the reflecting bodies 8 to the light emitting surface has values from about 10% to about 90%, which means that the luminance evenness is enhanced. Especially, in the range that the size ratio (X2) of the reflecting bodies 8 to the light emitting surface has values from about 10% to about 70%, the luminance evenness is more enhanced. The present inventors have confirmed that such the luminance evenness is a sufficient property as luminance evenness required to surface light emitting device 1. Therefore, in order to enhance the luminance evenness, it is preferable that upper light reflecting body 8a and lower light reflecting body 8b are arranged around the both end parts of the light emitting surface (in other words, around the both ends of substrate 6) such that X2 has the value within the range from about 10% to about 90% of X2, more preferably in the range from about 10% to about 70% of X2.

Herein, upper light reflecting body 8a and lower light reflecting body 8b arranged around the both end parts of the light emitting surface (in other words, around the both ends of substrate 6) are not required to have the same length (L3) strictly. The length of each reflecting body 8 may be adjusted according to a deviation of the luminance distribution of the light emitting surface under the condition that there are no reflecting bodies 8. Further, reflecting bodies 8 are not required to be arranged around the both end parts of the light emitting surface, and can be arranged around only one of the end parts to adjust the luminance evenness.

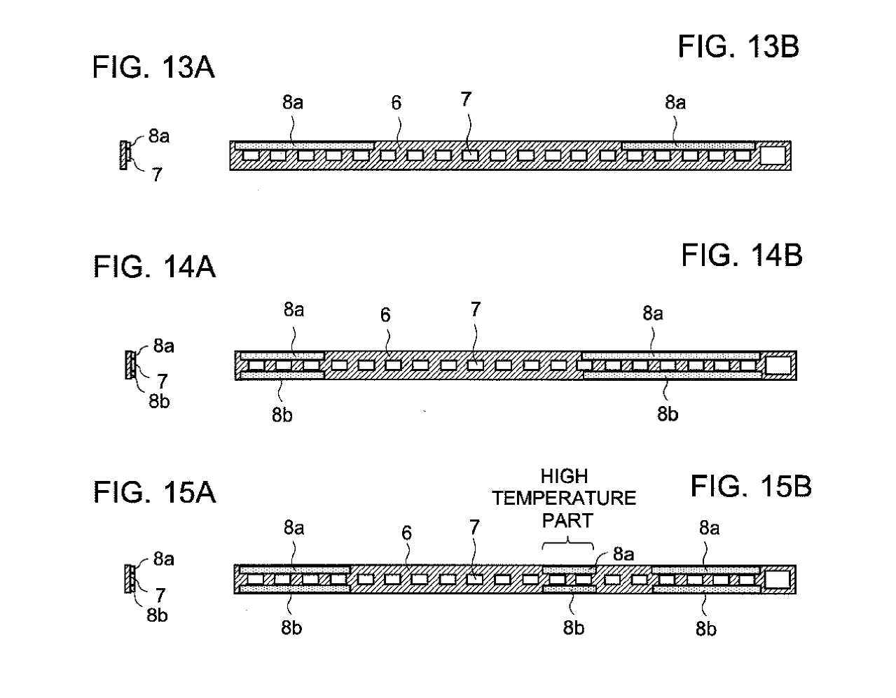

Further, the reflecting bodies 8 are not required to be arranged at the both sides of the light emitting bodies 7. For example, as shown in FIG. 12 and FIGS. 13A and 13B, only upper reflecting body 8a may be arranged or only lower reflecting body 8b may be arranged. However, reflection sheet 9 exists at the side of lower reflecting body 8b and reflection sheet 9 generally has higher reflectivity than frame 3. Therefore, regarding the effect to increase the luminance coming from reflecting bodies 8, the effect under the condition that only upper reflecting body 8a is arranged is greater than that under the situation that only the lower reflecting body 8b is arranged.

In the above descriptions, reflecting bodies 8 having almost the same length are arranged in the symmetric positions at the both sides of the center of the light emitting surface as the symmetry axis. However, the lengths of reflecting bodies 8 can be freely adjusted and reflecting bodies 8 can be arranged at asymmetric positions in the horizontal direction or in the vertical direction. For example, under the condition that the luminance distribution of light emitting bodies 7 is uneven and one of the end parts of the light emitting surface has lower luminance than that of the other, reflecting bodies 8 arranged at the end part having lower luminance (at the right-hand side in FIG. 14B) may have a longer length or a thicker thickness than the others as shown in FIGS. 14A and 14B.

Further in the above descriptions, reflecting bodies 8 are arranged around the end parts of the light emitting surface (in other words, around the both ends of substrate 6). However, under the condition that there exists a position where a part of light emitting bodies 7 have high temperature, reflecting bodies 8 may be arranged around the part of light emitting bodies 7 having high temperature, in place of reflecting bodies 8 arranged around at least one of the end parts or additionally to reflecting bodies 8 arranged around the both end parts. For example, under the condition that there is a high temperature part where light emitting bodies 7 has high temperature at a position a little to the right of the center as shown in FIG. 15B, arranging reflecting bodies 8 around the high temperature part can restrict a partial deterioration of luminance of the light emitting surface coming from a deterioration of the light emission efficiency due to heat generated by light emitting bodies 7, which enhances the luminance evenness of the whole light emitting surface.

That is, one feature of the present example is that reflecting bodies 8 are fixed continuously along the direction almost in parallel with the arrangement direction of light emitting bodies 7 and are fixed in at least one of the area at the side being closer to the light emitting surface of surface light emitting device 1 (closer to the principal surface of light guide plate 5) than light emitting bodies 7 or the area at the opposite side (closer to the rear surface of the light guide plate 5) of light emitting bodies 7. Here, the term “continuously” means that, on fixing each of reflecting bodies 8 onto an arbitrary area, each reflecting body in a linear shape keeps its shape one integrated body without being separated and divided discontinuously in the area.

As described above, a surface light emitting device generally has a trend that a light emitting surface has high luminance at the center, and the luminance decreases as the position goes toward a peripheral part of the light emitting surface. However, arranging reflecting bodies 8 in an area corresponding to a part of the light emitting surface where the luminance becomes low, enhances the efficiency of making light from light emitting bodies 7 enter light guide plate 5, namely the light utilization efficiency, which can enhance the luminance evenness. Thereby, the problems of the conventional arts can be solved and a surface light emitting device with excellent reliability and high luminance evenness can be realized.

### EXAMPLE 2

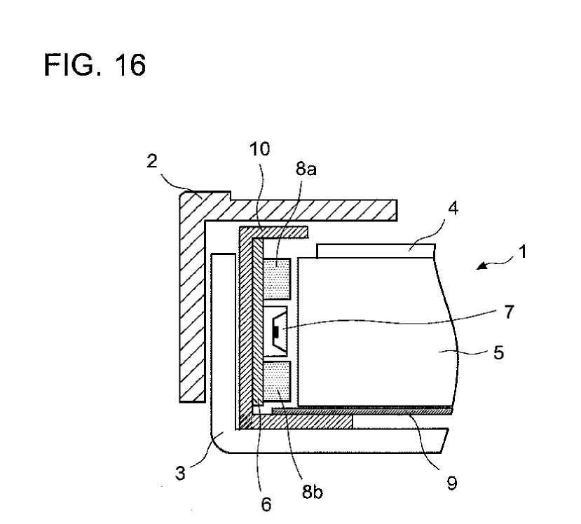

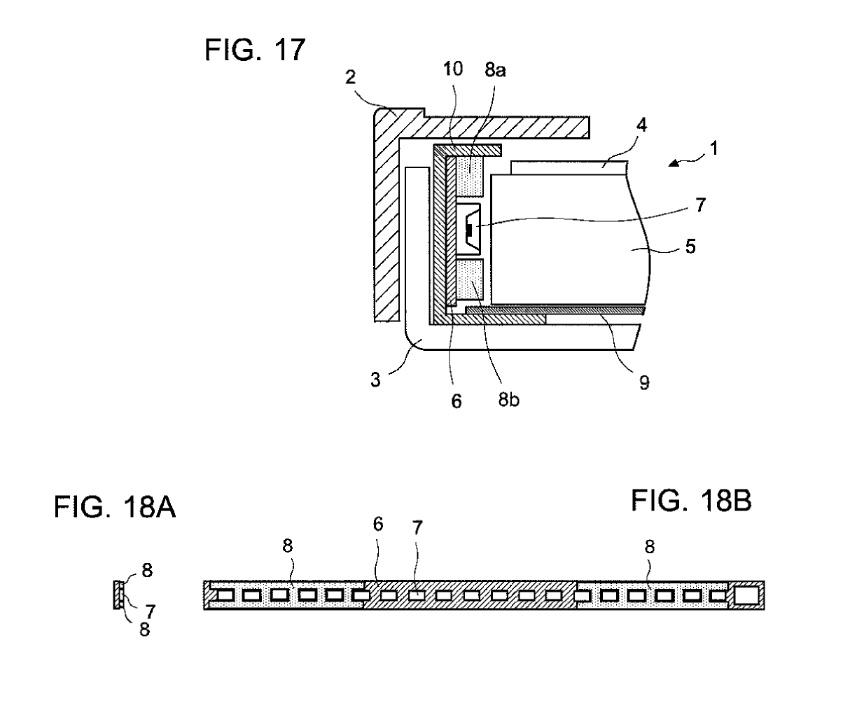

Next, descriptions of a surface light emitting device of Example 2 are given with reference to FIGS. 16 and 17.

In the above-described Example 1, there was provided substrate 6 on which light emitting bodies 7 and reflecting bodies 8 are arranged, and the substrate 6 was fixed onto rear frame 3. However, when adding a member for increasing the light utilization efficiency, adding a member for increasing the strength of surface light emitting device 1 or adding a member for combining the structural components into one unit, substrate 6 may be fixed onto such a member.

FIG. 16 is a cross-sectional view illustrating a structure of surface emitting device 1 of the present example. In FIG. 16, there is arranged reflector 10 for increasing the light utilization efficiency, at the position between frame 2 and rear frame 3 so as to cover substrate 6 from above in the direction from the principal-surface side of to the rear-surface side of light guide plate 5, and substrate 6 is fixed onto reflector 10 with a screw or the above-described adhesive agent. In this example, the structure and shape of each of reflecting bodies 8 are the same as those of Example 1.

FIG. 17 is a cross-sectional view illustrating another structure of surface emitting device 1 of the present example. Similarly to the structure shown in FIG. 16, there is arranged reflector 10 for increasing the light utilization efficiency, at the position between frame 2 and rear frame 3 so as to cover substrate 6 from above in the direction from the principal-surface side of to the rear-surface side of light guide plate 5, and substrate 6 is fixed onto reflector 10 with a screw or the above-described adhesive agent. As one feature of the present example, also upper reflecting body 8a is fixed onto reflector 10 with a screw or the above-described adhesive agent. In this example, the structure and shape of each of reflecting bodies 8 are the same as those of Example 1.

As described above, since substrate 6 and upper reflecting body 8a are fixed onto reflector 10 in illustrative structures of Example 2, substrate 6, light emitting bodies 7 and reflecting bodies 8 can be combined into one unit, which enhances mountability. Also the illustrative structures of Example 2, similarly to the structure of Example 1, can enhance the luminance evenness by increasing the luminance of a part having lower luminance, which can solve the problems of the conventional arts and realize a surface light emitting device 1 having excellent reliability and high luminance evenness.

### EXAMPLE 3

Next, descriptions of surface light emitting device of Example 3 are given with reference to FIGS. 18A and 18B.

In the above-described Example 1 and Example 2, there are arranged upper reflecting body 8a and lower reflecting body 8b at the upper part and the lower part of light emitting bodies, respectively. However, for increasing the light utilization efficiency, additional reflecting bodies 8 can be arranged on areas between neighboring light emitting bodies 7.

FIGS. 18A and 18B are a front view and a side view illustrating the reflecting bodies 8 in surface light emitting device 1 of the present example. Each of reflecting bodies 8 shown in FIGS. 18A and 18B has a structure to cover the upper part and lower part of the light emitting bodies 7 and a space between light emitting bodies 7, and has almost the same width as the substrate 6. There are formed hole sections on certain areas of each reflecting body 8, where the certain areas correspond to the positions of respective light emitting bodies 7.

As described above, the structure of Example 3 employs reflecting bodies having increased areas in comparison with those of Example 1 and Example 2, and such the structure increases the luminance of the area where reflecting bodies 8 are arranged, which can much more enhance the luminance evenness. Also the structure of Example 3, similarly to the structure of Example 1, can solve the problems of the conventional arts and realize a surface light emitting device 1 having excellent reliability and high luminance evenness.

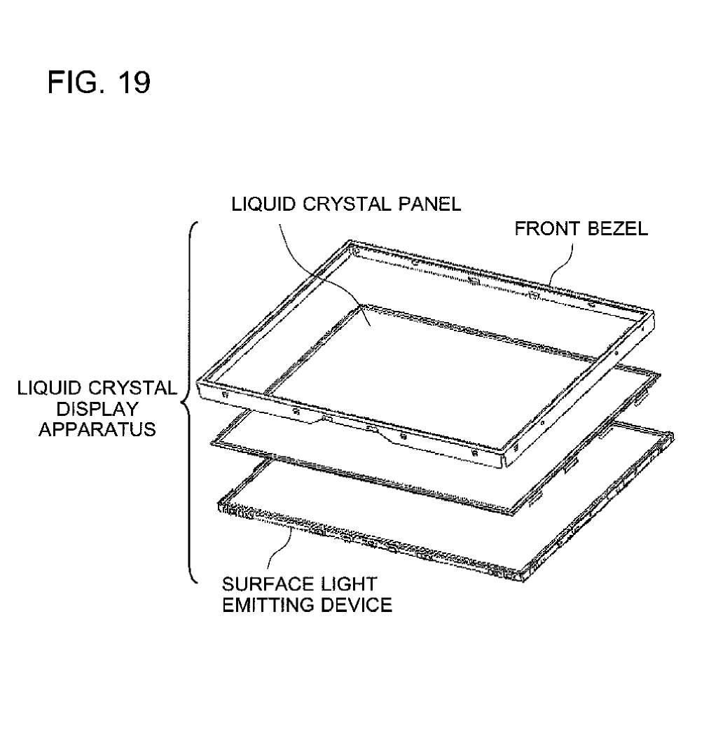

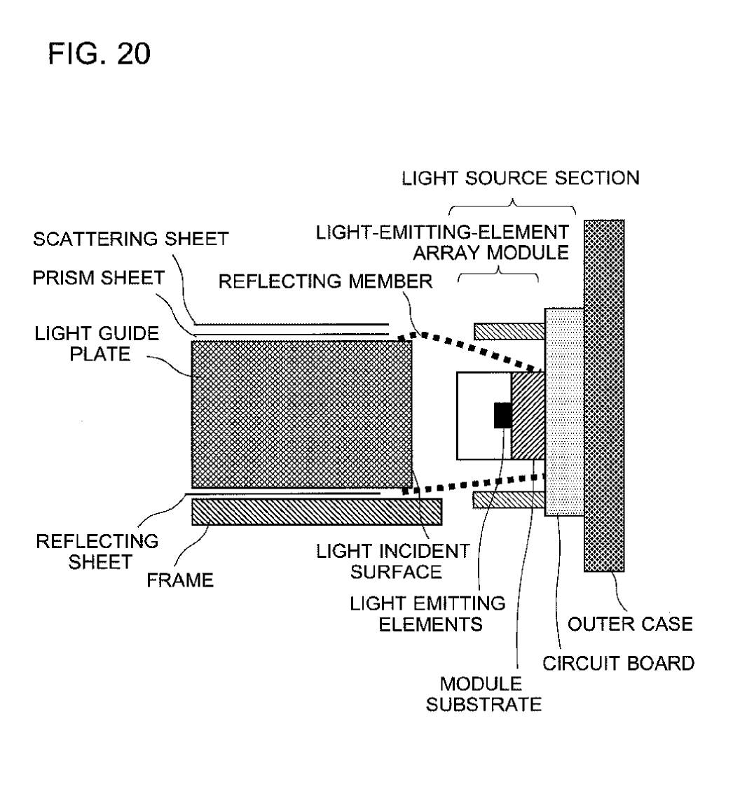

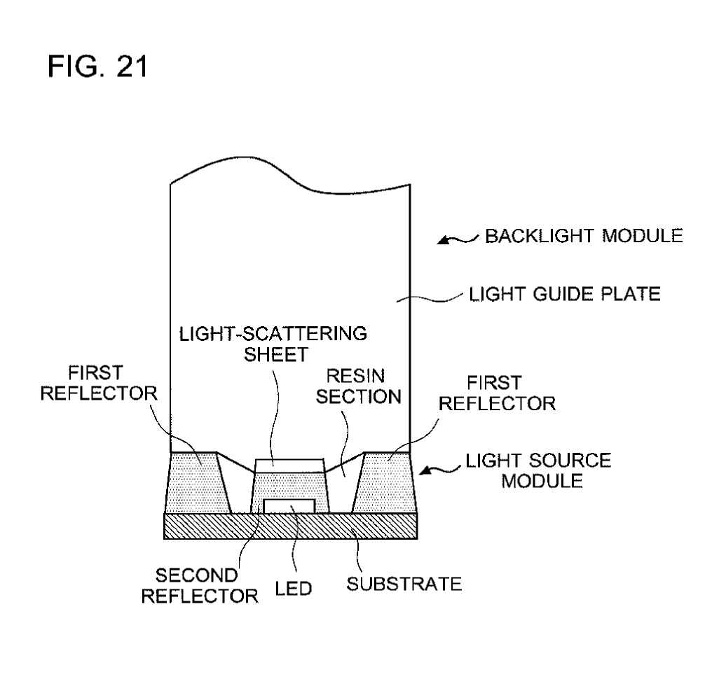

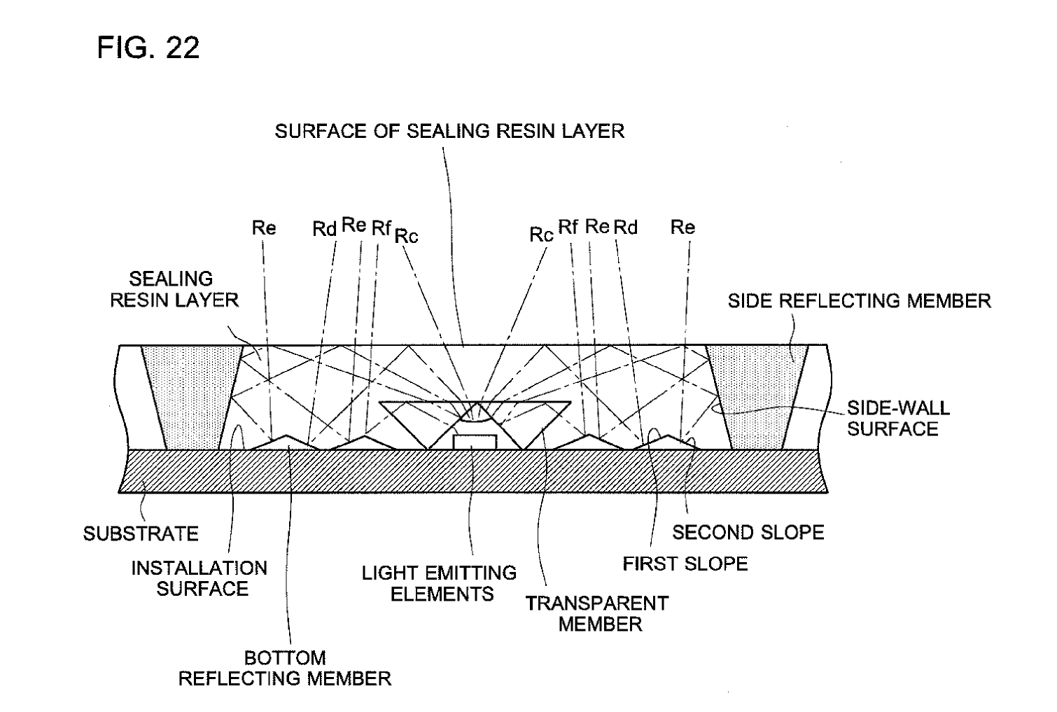

FIG. 19 illustrates a perspective view of a liquid crystal display apparatus equipped with a surface light emitting device of any one of the above examples. The liquid crystal display apparatus includes a front bezel, a liquid crystal panel and the surface light emitting device of any one of the above examples.

The scope of the present invention is not limited to the aforementioned examples. Disclosed configurations and arrangement of the aforementioned surface light emitting devices 1, especially, the shape, arrangement and material of the aforementioned reflection bodies 8 can be varied by a skilled person without departing from the spirit and scope of the invention.

For example, each of the above examples described about plural light emitting bodies 7 arrayed in one line, but the structures of the aforementioned examples are similarly applicable to a structure that light emitting bodies are arrayed in plural lines. For example, when light emitting bodies 7 are arranged in two lines, reflecting bodies 8 may be arranged in the upper area of the upper line of light emitting bodies 7 and the lower area of the lower line of light emitting bodies 7, and other reflecting bodies 8 may be arranged in an area between the upper line and the lower line of the light emitting bodies 7.

Further, light emitting bodies 7 may be arranged with facing one longitudinal side or opposite two longitudinal sides of light guide plate 5, or facing one shorter side or opposite two shorter sides of light guide plate 5, or may be arranged to form a L shape with facing one longitudinal side and one shorted side of the light guide plate 5.

Further, the above examples described about the structures that a linear light source formed by arranging light emitting bodies 7 in one direction is converted into a surface light source. However, reflecting bodies 8 of the above examples may be arranged for a point light source formed by one light emitting body 7, so that the luminance evenness can be enhanced.

1. A surface light emitting device comprising:
a light guide plate in a flat plate shape, including a side surface through which light enters, a principal surface through which the light goes out and a rear surface opposite to the principal surface;
a reflection sheet arranged on the rear surface of the light guide plate;
a substrate arranged with facing the side surface of the light guide plate;
a plurality of light emitting bodies arranged along a longitudinal direction of the substrate and mounted on a surface of the substrate, the surface facing the light guide plate;
a frame and a rear frame holding at least the substrate, the light guide plate and the reflection sheet by being arranged at a side of the principal surface and a side of the rear surface of the light guide plate, respectively; and
one or more reflecting bodies arranged around a part of the light emitting bodies and extending along a longitudinal side of the surface of the substrate.

2. The surface light emitting device of claim 1,
wherein the reflecting bodies are arranged around the light emitting bodies arranged on both ends of the substrate.

3. The surface light emitting device of claim 1,
wherein the one or more reflecting bodies are arranged around one of the light emitting bodies having lower luminance than others of the light emitting bodies.

4. The surface light emitting device of claim 1,
wherein the surface of the substrate facing the light guide plate includes two longitudinal sides of a principal-surface-side longitudinal side and a rear-surface-side longitudinal side, the principal-surface-side longitudinal side is closer to the principal surface of the light guide plate than the other, and the rear-surface-side longitudinal side is closer to the rear surface of the light guide plate than the other, and
wherein the one or more reflecting bodies are arranged in at least one of an area between the light emitting bodies and the principal-surface-side longitudinal side, and an area between the light emitting bodies and the rear-surface-side longitudinal side.

5. The surface light emitting device of claim 1,
wherein a ratio of a length of the one or more reflecting bodies to a width of the principal surface of the light guide plate is 10% or more, and is 70% or less, where the length of the one or more reflecting bodies and the width of the principal surface are measured in the longitudinal direction of the substrate.

6. The surface light emitting device of claim 1,
wherein the one or more reflecting bodies are arranged such that at least one of the one or more reflecting bodies has a top located between light emitting surfaces of the light emitting bodies and the side surface of the light guide plate, when being viewed along a normal direction of the substrate.

7. The surface light emitting device of claim 1,
wherein the one or more reflecting bodies are fixed with an adhesive to one of the substrate, the rear frame, the reflection sheet and a reflector covering the substrate from above in a direction from the principal surface to the rear surface.

8. The surface light emitting device of claim 1,
wherein each of the one or more reflecting bodies comprises a foamed polymer material in white color.

9. The surface light emitting device of claim 8,
wherein each of the one or more reflecting bodies is 0.25 mm or greater in thickness.

10. The surface light emitting device of claim 8,
wherein each of the one or more reflecting bodies comprises an ultraviolet absorbing agent or an ultraviolet absorbing film.

11. A liquid crystal display apparatus comprising the surface light emitting device of claim 1.
